(19) United States
(12) Patent Application Publication
(10) Pub. No.: US 2013/0200799 A1
(43) Pub. Date: Aug. 8, 2013

(54) High-Voltage AC LED Driver Circuit

(71) Applicant: Luxul Technology Incorporation, New Taipei City (TW)

(72) Inventor: Cheng-Hung Pan, New Taipei City (TW)

(73) Assignee: LUXUL TECHNOLOGY INCORPORATION, New Taipei City (TW)

(21) Appl. No.: 13/746,852

(22) Filed: Jan. 22, 2013

(30) Foreign Application Priority Data
Feb. 6, 2012 (TW) 101103739

(51) Int. Cl. H05B 33/08

(52) U.S. Cl. CPC H05B 33/0887
USPC 315/121

(57) ABSTRACT

A high-voltage AC LED driver circuit has a rectifier unit, an LED unit, a voltage-controlled transistor, a current detection unit, a control unit and a shunt unit. The shunt unit has a current limiting transistor for limiting a current flowing through the shunt unit to be lower than the working current. The current flowing through the voltage-controlled transistor will be higher than 0 (A) although an AC voltage is boosted. In addition, the voltage-controlled transistor can extend its working voltage and is prevented from being over heated.

### CROSS-REFERENCE TO RELATED APPLICATIONS

This application claims the benefit of Taiwan patent application No. 101103739, filed on Feb. 6, 2012, the disclosure of which is incorporated herein in its entirety by reference.

### BACKGROUND OF THE INVENTION

1. Field of the Invention

The present invention relates to an AC LED driver circuit, and more particularly to a high-voltage AC LED driver circuit.

2. Description of Related Art

LED (light emitting diode) is a common illumination device nowadays. Compared to a conventional incandescent light bulb, LED has advantages of high luminous efficiency and low power consumption. The LED can be activated only by a forward bias, such that LED is hardly applied to conventional AC power socket. Hence, an LED driver circuit is developed to make the LED applicable for the conventional AC power socket. With reference to FIG. 5, the LED driver circuit comprises a rectifier unit 20, an LED unit 21, a voltage-controlled transistor 22, a current detection unit 23, a low-pass filter 24 and a control unit 25.

An input terminal of the rectifier unit 20 is connected to an AC power (AC/IN) to receive an AC voltage. The rectifier unit 20 converts the AC voltage to a pulsed DC voltage and outputs the pulsed DC voltage through an output terminal

The LED unit 21 comprises multiple LED devices and is connected to the output terminal of the rectifier unit 20 to form a current loop.

The voltage-controlled transistor 22 is connected to the current loop in series and has a control terminal. The voltage-controlled transistor 22 is activated to adjust a working current (Iw) flowing through the current loop.

The current detection unit 23 is connected to the current loop in series to generate a detection signal according to the working current.

The low-pass filter 24 is connected to the current detection unit 23 to generate an average voltage signal based on the detection signal of the current detection unit 23.

An input terminal of the control unit 25 is connected to the low-pass filter 24 to receive the average voltage signal. Another input terminal of the control unit 25 receives a reference voltage signal (Vref). An output terminal of the control unit 25 is connected to the control terminal of the voltage-controlled transistor 22. The control unit 25 compares the reference voltage signal with the average voltage signal. According to a comparison result, the control unit 25 outputs a control signal to the control terminal of the voltage-controlled transistor 22 to stabilize the working current of the current loop.

The LED driver circuit converts the AC voltage, which is inapplicable for the LED, to the pulsed DC voltage. The current detection unit 23 and the low-pass filter 24 sense an average current of the working current for providing the control unit 25. The control unit 25 then stabilizes the working current by controlling the voltage-controlled transistor 22. Hence, the LED unit 21 can illuminate uniformly.

However, the voltage-controlled transistor 22 is directly connected to the current loop in series. The voltage-controlled transistor 22 is easily over heated resulting from sustaining high current. To resolve the overheating condition, a shunt resistor 26 is connected to the voltage-controlled transistor 22 in parallel. Even though the shunt resistor 26 shares the working current (Iw) with the voltage-controlled transistor 22 to reduce the heat accumulation of the voltage-controlled transistor 22, with reference to FIGS. 6 and 7, a maximum working voltage (Vds) of the voltage-controlled transistor 22 is limited by the shunt resistor 26. For example, when the working current (Iw) is 0.16 (A) and the maximum rated power of the voltage-controlled transistor 22 is 1 (W), the maximum working voltage (Vds) of the voltage-controlled transistor 22 is limited to 25 (V). When the working voltage (Vds) of the voltage-controlled transistor 22 is boosted to be higher than 25 (V), a current (Imos) flowing through the voltage-controlled transistor 22 will be 0 (A). The working current (Iw) may totally flow through the shunt resistor 26, i.e. Iw=IR. The voltage-controlled transistor 22 then operates in cut-off region and is disabled from stabilizing the working current (Iw). In conclusion, when the LED driver circuit is applied to the AC power (AC/IN), the LED driver circuit cannot work normally. The LED driver circuit obviously needs further improvement.

### SUMMARY OF THE INVENTION

An objective of the invention is to provide a high-voltage AC LED driver circuit. The driver circuit of the invention can operate at high power under high AC voltage.

The high-voltage AC LED driver circuit comprises:

a rectifier unit converting an AC voltage to a pulsed DC voltage and outputting the pulsed DC voltage;

an LED unit comprising multiple LED devices and connected to the rectifier unit to form a current loop, wherein a working current flows through the current loop;

a voltage-controlled transistor connected in the current loop and having a control terminal;

a current detection unit connected to the current loop in series to generate a detection signal corresponding to the working current;

a low-pass filter connected to the current detection unit to output an average voltage signal according to the detection signal of the current detection unit;

a control unit having:
a first input terminal connected to the low-pass filter to receive the average voltage signal;
a second input terminal receiving a reference voltage signal; and
an output terminal connected to the control terminal of the voltage-controlled transistor to output a control signal to the voltage-controlled transistor to stabilize the working current according to a comparison result of the average voltage signal and the reference voltage signal; and

a shunt unit connected in the current loop and the voltage-controlled transistor in parallel and having:
a shunt resistor; and
a current limiting transistor connected to the shunt resistor in series, wherein the current limiting transistor is activated by receiving a constant control voltage signal, such that a current flowing through the shunt unit is lower than the working current.

With respect to the driver circuit, because the working current is stabilized by the voltage-controlled transistor, the detection signal of the current detection unit is constant. A voltage on a source of the current limiting transistor keeps constant. In addition, the control terminal of the current limiting transistor receives the constant control voltage signal, so that a constant voltage is formed between the control terminal and the source of the current limiting transistor. A current flowing through the shunt unit is lower than the working current.

When a working voltage between a drain and a source of the voltage-controlled transistor is boosted, the current flowing through the shunt unit is increased. The current limiting transistor can be activated to stop the current of the shunt unit from rising. Hence, the current of the voltage-controlled transistor is always higher than 0 (A), so that the voltage-controlled transistor is prevented from operating in cut-off region. The working voltage of the voltage-controlled transistor can be effectively boosted.

### BRIEF DESCRIPTION OF THE DRAWINGS

FIG. 1 is a circuit block diagram of the driver circuit of the invention;

FIG. 2 is a circuit block diagram of the driver circuit with a voltage divider of the invention;

FIG. 3 is a waveform diagram of the relationship between power and working voltage of the voltage-controlled transistor of the invention;

FIG. 4 is a waveform diagram of the relationship between temperature and voltage of the voltage controlled transistor of the invention;

FIG. 5 is a circuit block diagram of a conventional LED driver circuit;

FIG. 6 is a waveform diagram of the relationship between power and working voltage of the conventional voltage-controlled transistor; and

FIG. 7 is a waveform diagram of the relationship between temperature and working voltage of the conventional voltage-controlled transistor.

### DETAILED DESCRIPTION OF THE PREFERRED EMBODIMENT

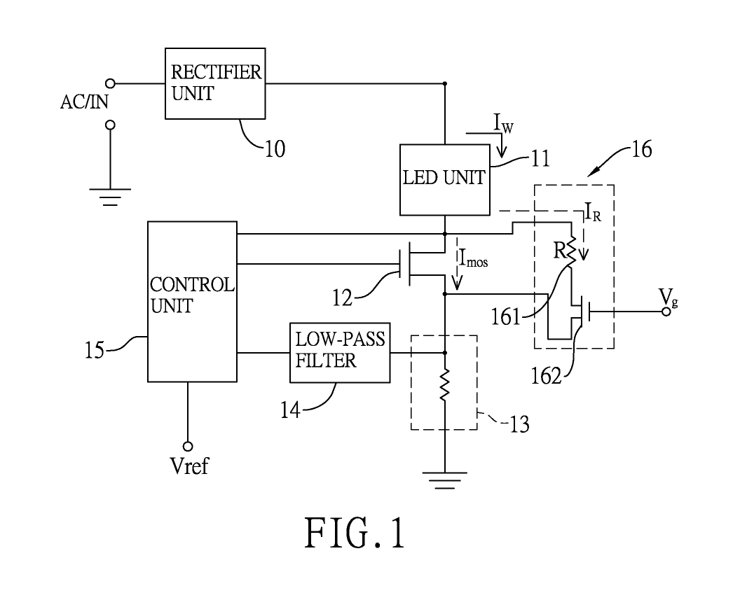

With reference to FIG. 1, the high-voltage AC LED driver circuit of the invention comprises a rectifier unit 10, an LED unit 11, a voltage-controlled transistor 12, a current detection unit 13, a low-pass filter 14, a control unit 15 and a shunt unit 16.

An input terminal of the rectifier unit 10 is connected to an AC power (AC/IN) to receive an AC voltage. The rectifier unit 10 converts the AC voltage to a pulsed DC voltage and outputs the pulsed DC voltage through an output terminal. The rectifier unit 10 can be a full-wave rectifier or a half-wave rectifier. In this embodiment, the rectifier unit 10 is a full-wave rectifier.

The LED unit 11 is connected to the output terminal of the rectifier unit 10 to form a current loop. The LED unit 11 has multiple LED devices connected in series or in parallel. The LED unit 11 is activated by the pulsed DC voltage of the rectifier unit 10. A working current (Iw) flows through the current loop.

The voltage-controlled transistor 12 is connected in the current loop of the LED unit 11 and the rectifier unit 10 and has a control terminal. The voltage-controlled transistor 12 can be a MOSFET or a JFET. In this embodiment, the voltage-controlled transistor 12 is a MOSFET with a gate as the control terminal, a drain and a source. The drain and the source are connected in the current loop. A voltage between the drain and the source is defined as a working voltage. A first current (Imos) flowing through the drain and the source is adjusted by a voltage between the gate and the source of the voltage-controlled transistor 12.

The current detection unit 13 is connected to the voltage-controlled transistor 12 and the current loop of the LED unit 11 and the rectifier unit 10 in series. In this embodiment, the current detection unit 13 is a detection resistor 131. The current detection unit 13 generates a detection signal corresponding to the working current, wherein the detection signal is a voltage across the detection resistor 131.

The low-pass filter 14 has an input terminal and an output terminal. The input terminal is connected to a node between the voltage-controlled transistor 12 and the current detection unit 13 to receive the detection signal from the current detection unit 13. The low-pass filter 14 then outputs an average voltage signal through the output terminal. The average voltage signal corresponds to an average current of the working current (Iw). The low-pass filter 14 can be an analog filter composed of capacitors and inductors or a digital filter composed of digital circuits. In this embodiment, the low-pass filter 14 is a digital filter and can be a down-sampling filter. The down-sampling filter oversamples and converts the detection signal to the average voltage signal. Hence, the average voltage signal can immediately reflect the average working current flowing through the current loop.

The control unit 15 has a first input terminal, a second input terminal and an output terminal. The first input terminal is connected to the output terminal of the low-pass filter 14. The second input terminal receives a reference voltage signal. The output terminal of the control unit 15 is connected to the control terminal of the voltage-controlled transistor 12. The control unit 15 compares the average voltage signal of the low-pass filter 14 with the received reference voltage signal. When the average voltage signal is higher than the reference voltage signal, the control unit 15 outputs a control signal to the control terminal of the voltage-controlled transistor 12 to reduce the working current (Iw). When the average voltage signal is lower than the reference voltage signal, the control unit 15 outputs the control signal to the control terminal of the voltage-controlled transistor 12 to boost the working current (Iw). Hence, the control unit 15 stabilizes the working current (Iw) by controlling the voltage-controlled transistor 12.

The shunt unit 16 is connected to the voltage-controlled transistor 12 in parallel and has a shunt resistor 161 and a current limiting transistor 162 connected to the shunt resistor 161 in series. The current limiting transistor 162 has a source, a drain and a gate as a control terminal for receiving a constant control voltage signal (Vg).

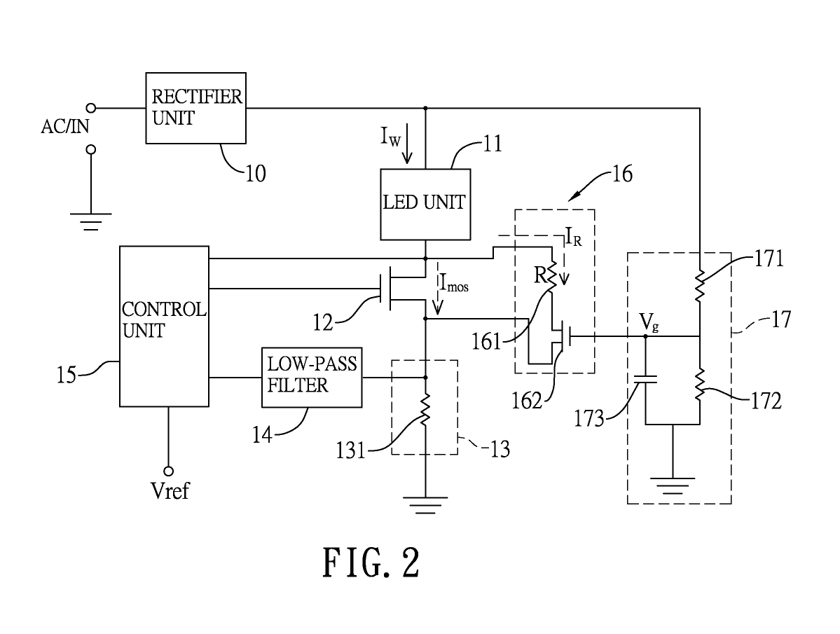

With reference to FIG. 2, the shunt unit 16 further has a voltage divider 17 adapted to generate the control voltage signal (Vg). The voltage divider 17 has a first resistor 171, a second resistor 172 and a filter capacitor 173. The first resistor 171 is connected to the second resistor 172 in series. The filter capacitor 173 is connected to the second resistor 172 in parallel. In this embodiment, an input terminal of the voltage divider 17 is connected to the output terminal of the rectifier unit 10. The voltage divider 17 receives the pulsed DC voltage and divides the pulsed DC voltage into the control voltage signal (Vg). The input terminal of the voltage divider 17 can also be connected to other power supply instead of the rectifier unit 10.

Because the voltage-controlled transistor 12 is responsible for keeping the working current (Iw) of the current loop stable, the voltage across the detection resistor 131 is constant. The voltage on the source of the current limiting transistor 162 is reasonably constant. The gate of the current limiting transistor 162 receives the constant control voltage signal (Vg) from the voltage divider 17. Hence, a constant bias is formed between the gate and the source of the current limiting transistor 162.

As for the constant bias, when a working voltage between the drain and the source of the current limiting transistor 162 is higher than the constant bias (Vgs), the current limiting transistor 162 then operates in saturation region. When the AC LED driver circuit of the invention receives a high AC voltage, the working voltage of the current limiting transistor 162 is boosted. Hence, the working voltage of the current limiting transistor 162 is higher than the constant bias (Vgs), such that the current limiting transistor 162 operates in saturation region. A current (I_{R}) flowing through the shunt unit 16 is limited to lower than the working current (Iw). A current (Imos) of the voltage-controlled transistor 12 is always higher than 0 (A). Hence, the voltage-controlled transistor 12 can operate in saturation region instead of operating in cut-off region. The current (Imos) flowing through the voltage-controlled transistor 12 is far lower than the current (I_{R}) flowing through the current limiting transistor 162. When the working voltage of the voltage-controlled transistor 12 is boosted, a working power of the voltage-controlled transistor 12 is gradually increased. Afterward, the voltage-controlled transistor 12 can operate at maximum working power without being over heated. A range of the working voltage of the voltage-controlled transistor 162 extends.

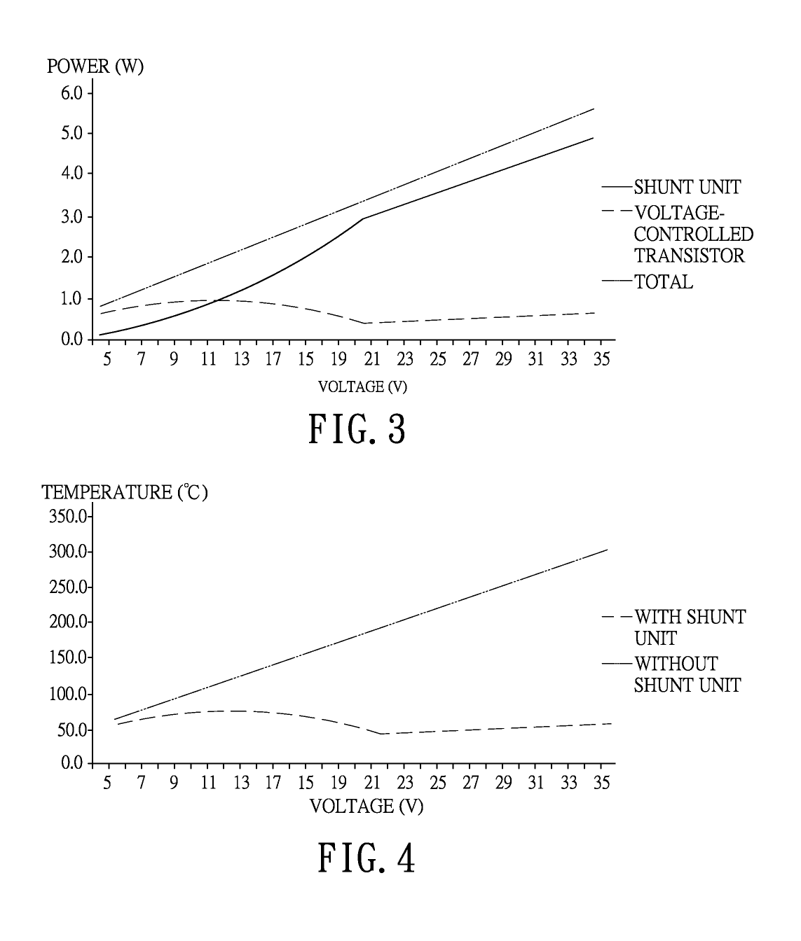

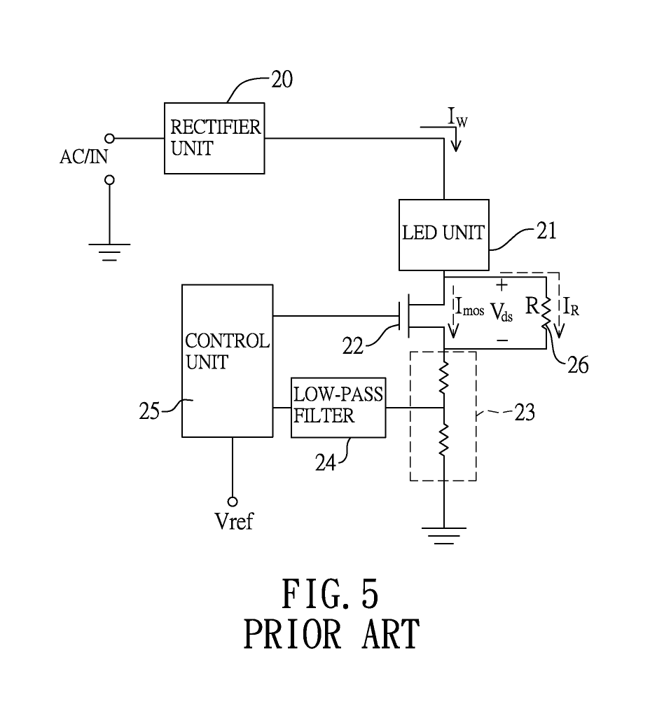

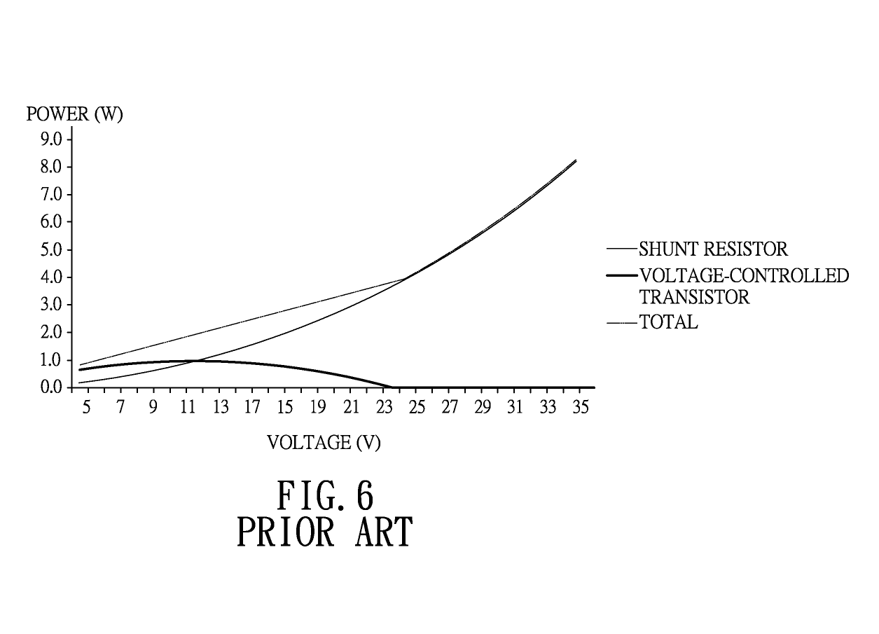

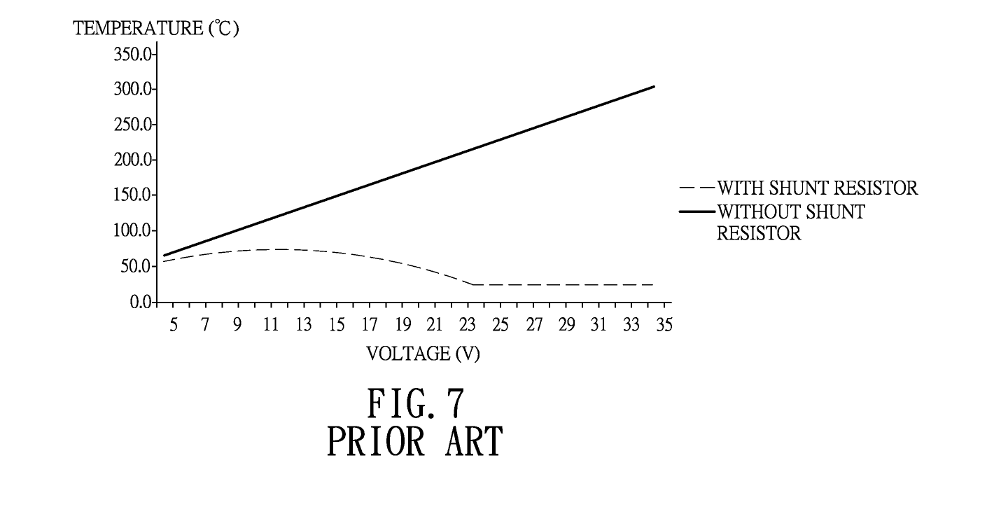

With reference to FIG. 3, for example, the working current (Iw) is 0.16 (A) and the shunt resistor 161 is 160 (Ω). The voltage-controlled transistor 12 sustains 35 (V) and a maximum working power of the voltage-controlled transistor 12 is 1 (W). When the working voltage of the voltage-controlled transistor 12 is above 21 (V), the shunt unit 16 limits the current (I_{R}) to 0.14 (A). The current (Imos) of the voltage-controlled transistor 12 is then limited to 0.02. Therefore, the voltage-controlled transistor 12 can operate at the maximum working power of 1 (W) and the working voltage can be extended to 35 (V) from 21 (V). The AC LED driver circuit of the invention is not over heated under high AC voltage.

With reference to FIG. 4, for example, a temperature coefficient of the voltage-controlled transistor 12 is 50 (° C./W). The broken line and the catenary line respectively stand for the temperature characteristic of the voltage-controlled transistor 12 with and without the shunt unit 16. The temperature of the voltage-controller transistor 12 with the shunt unit 16 is limited to lower than 80° C. The temperature of the voltage-controller transistor 12 without the shunt unit 16 is easily increased above 100° C., even above 150° C.

In conclusion, the AC LED driver circuit of the invention is properly applied to high AC voltage. The voltage-controlled transistor keeps operating in saturation region and does not turn to cut-off region. The voltage-controlled transistor is also prevented from being over heated.

What is claimed is:

1. A high-voltage AC LED driver circuit comprising:
a rectifier unit converting an AC voltage to a pulsed DC voltage and outputting the pulsed DC voltage;
an LED unit comprising multiple LED devices and connected to the rectifier unit to form a current loop, wherein a working current flows through the current loop;
a voltage-controlled transistor connected to the current loop and having a control terminal;
a current detection unit connected to the current loop in series to generate a detection signal corresponding to the working current;
a low-pass filter connected to the current detection unit to output an average voltage signal according to the detection signal of the current detection unit;
a control unit having:
a first input terminal connected to the low-pass filter to receive the average voltage signal;
a second input terminal receiving a reference voltage signal; and
an output terminal connected to the control terminal of the voltage-controlled transistor to output a control signal to the voltage-controlled transistor to stabilize the working current according to a comparison result of the average voltage signal and the reference voltage signal; and
a shunt unit connected in the current loop and the voltage-controlled transistor in parallel and having:
a shunt resistor; and
a current limiting transistor connected to the shunt resistor in series, wherein the current limiting transistor is activated by receiving a constant control voltage signal, such that a current flowing through the shunt unit is lower than the working current.

2. The driver circuit as claimed in claim 1, wherein the shunt unit further has a voltage divider for generating the constant control voltage signal.

3. The driver circuit as claimed in claim 1, wherein
the current detection unit has a detection resistor; and
a voltage across the detection resistor is the detection signal.

4. The driver circuit as claimed in claim 2, wherein
the current detection unit has a detection resistor; and
a voltage across the detection resistor is the detection signal.

5. The driver circuit as claimed in claim 1, wherein the low-pass filter is an analog filter.

6. The driver circuit as claimed in claim 2, wherein the low-pass filter is an analog filter.

7. The driver circuit as claimed in claim 3, wherein the low-pass filter is an analog filter.

8. The driver circuit as claimed in claim 4, wherein the low-pass filter is an analog filter.

9. The driver circuit as claimed in claim 1, wherein the low-pass filter is a digital filter.

10. The driver circuit as claimed in claim 2, wherein the low-pass filter is a digital filter.

11. The driver circuit as claimed in claim 3, wherein the low-pass filter is a digital filter.

12. The driver circuit as claimed in claim 4, wherein the low-pass filter is a digital filter.

13. The driver circuit as claimed in claim 9, wherein the digital filter is a down-sampling filter.

14. The driver circuit as claimed in claim 10, wherein the digital filter is a down-sampling filter.

15. The driver circuit as claimed in claim 1, wherein the voltage-controlled transistor is a MOSFET having:
a gate as the control terminal;
a drain connected to the current loop; and
a source connected to the current loop.

16. The driver circuit as claimed in claim 2, wherein the voltage-controlled transistor is a MOSFET having:
a gate as the control terminal;
a drain connected to the current loop; and
a source connected to the current loop.

17. The driver circuit as claimed in claim 3, wherein the voltage-controlled transistor is a MOSFET having:
a gate as the control terminal;
a drain connected to the current loop; and
a source connected to the current loop.

18. The driver circuit as claimed in claim 4, wherein the voltage-controlled transistor is a MOSFET having:
a gate as the control terminal;
a drain connected to the current loop; and
a source connected to the current loop.
